(19) United States
(12) Patent Application Publication
(10) Pub. No.: US 2012/0161503 A1
(43) Pub. Date: Jun. 28, 2012

(54) AXLE SYSTEM FOR A TWO-WHEELED VEHICLE

(76) Inventor: Martin Achenbach, Biel (CH)

(21) Appl. No.: 13/164,862

(22) Filed: Jun. 21, 2011

(30) Foreign Application Priority Data
Jun. 21, 2010 (DE) 10 2010 024 473.2

(51) Int. Cl. B60B 35/00

(52) U.S. Cl. 301/124.2; 301/125

(57) ABSTRACT

Axle system and two-wheeler component having an axle system for a two-wheeler with an axle and a clamping mechanism comprising a tightening device at a first end portion of the axle and an end portion at a second end portion of the axle. The clamping mechanism is equipped to clampingly attach to a two-wheeler component a wheel received between the tightening device and the end device. The tightening device comprises an externally threaded, inner tightening member interacting with an internal threaded, outer tightening member which are axially displaceable relative to one another for tightening by way of rotating, an external diameter of the inner tightening member being larger than an external diameter of the axle at the second end portion.

The present invention relates to an axle system for a two-wheeled vehicle and in particular for a bicycle operated by muscular energy at least in part. The bicycle may be provided with an auxiliary motor drive configured in particular as an electric motor to assist the rider if and as desired. Use is likewise conceivable with other bi- and multicycles.

Various axle systems with a quick release mechanism have become known in the prior art to allow fast and comfortable mounting and demounting of bicycle wheels.

In many of the quick releases for bicycles as known in the prior art the clamping force is applied by flipping an eccentric member after adapting the clamping length by means of a tightening nut and a stopper. The drawback of this system is that first the clamping length must be set by means of the tightening nut before the clamping length and the clamping force can be checked by flipping the eccentric member. As a rule a number of cycles is required until the proper clamping length and thus the clamping force are suitable.

Due to safety requirements for quick releases the dropouts of modern bicycles tend to be configured not smooth but comprising end bearings for the axle system so as to initially ensure continued safe accommodation of the axle system at the dropouts even after releasing the clamping force. Because of these end bearings or lugs at the dropouts the opened distance must be enlarged wherein the stroke length of a classic quick release lever obtained by flipping the eccentric member is not always sufficient to release the clamping force and to overcome the additionally required lift for overcoming the additional end bearings. Therefore many systems require to operate not only the quick release lever but also to turn the screw nut on the opposite side in the opening direction for removing the wheel every time that a wheel is released and later clamped. Thus the axle system must be adjusted with every wheel change.

In EP 1 801 005 B1 a quick release in particular for bicycles has become known offering greater ease of operation. In this quick release the clamping force is not applied by flipping an eccentric member but via a screwed connection. A spring mechanism allows to pull the operating lever axially outwardly out of engagement and to freely turn it back in to quickly tighten the quick release. The known system operates reliably and allows precise adjustment of the clamping force required. Moreover the operating lever may be rotated to any desired direction after setting the clamping force.

Due to safety requirements and the increased opened distance which may be for example 5 mm, the quick release lever must be rotated approximately 5 or 6 turns every time that a wheel is released and later clamped, before the wheel can be removed or is again reliably clamped.

Against the cited prior art it is the object of the present invention to provide an axle system allowing greater ease of operation and possibly faster wheel changes.

This object is solved by an axle system having the features of claim 1 and by a two-wheeler component having the features of claim 23. Preferred more specific embodiments of the invention are the subjects of the subclaims. Further advantages and features of the present invention can be taken from the exemplary embodiments.

The axle system according to the invention is provided for a two-wheeled vehicle and in particular for a bicycle, comprising at least one axle and at least one clamping mechanism. The clamping mechanism comprises at least one tightening device at a first axle end portion and at least one end device at a second axle end portion. The clamping mechanism is equipped to clampingly attach to a two-wheeler component a wheel received between the tightening device and the end device. The tightening device comprises an externally threaded, inner tightening member interacting with an internally threaded, outer tightening member. Rotating the inner counter to the outer tightening member allows axial displacement of the inner relative to the outer tightening member and thus clamping of the clamping mechanism. An external diameter of the inner tightening member is larger than an outer axle diameter at the second end portion.

The axle system according to the invention has many advantages. A considerable advantage of the axle system according to the invention is that the inner tightening member is axially displaced relative to the outer tightening member by way of the internal thread engaging with the external thread, the outer diameter of the external thread of the inner tightening member being larger than the external axle diameter at the second end portion. The considerably larger outer diameter allows a higher thread pitch than do smaller diameter threads.

For example when employing a typical axle having an outer diameter of 5 mm and a thread pitch of 0.8 mm per rotation, then bridging a clamping distance of 5 mm requires more than six full rotations of the thread and thus of the operating lever to securely clamp a wheel. Now when employing a prior art axle having a large outer diameter of 9 mm and a thread pitch of 1 mm per rotation, then bridging a clamping distance of 5 mm requires five full rotations of the thread and thus of the operating lever to securely clamp a wheel.

Now, when employing a tightening member of 13.5 mm outer diameter in the same relative conditions, then the thread pitch is 1.5 mm per full rotation. Overcoming a distance of 5 mm only requires 3 ⅓ full rotations of the operating lever. The higher thread pitch notwithstanding, the considerably larger peripheral surface of the thread at a higher thread pitch achieves a safe, self-locking thread.

Enlarging the thread of the inner and the outer tightening members will thus on the whole result in a clearly increased operating comfort in mounting and demounting the wheel.

Operation preferably involves a system as it is disclosed in EP 1 801 005 B1, such that the disclosure of EP 1 801 005 B1 is presently included in its entirety.

The axle system provides for a rotation of the inner counter to the outer tightening member in a first rotational direction to decrease the distance between the tightening device and the end device for clamping a wheel, while a rotation of the inner and the outer tightening members in an opposite, second rotational direction increases the distance between the tightening device and the end device for example for removing a wheel from the fork or the frame of a bicycle.

In a preferred more specific embodiment the outer tightening member and the inner tightening member each comprise a stopper to receive the outer tightening member at the axle system secure against loss. The two stoppers limit an axial displacement of the inner and the outer tightening member toward the first end portion.

Receiving the outer tightening member secure against loss is advantageous since no searching for the outer tightening member is required for example if it comes undone from the axle and drops down as the clamping force is released.

The outer tightening member comprises in particular a clamping surface for placement against a two-wheeler component. This means that the inner tightening member preferably only serves as a coupling element or transmitting element transmitting the rotation of an opening or closing movement via the external thread of the inner tightening member to the internal thread of the outer tightening member. The outer tightening member is axially displaced corresponding to the rotary movement and, given rotary movement in the clamping direction, with its clamping surface clampingly bears against the corresponding contact surface of the two-wheeler component. This two-wheeler component may for example be configured as a fork, serving to receive a front wheel. Or else it is conceivable for the two-wheeler component to be configured as a frame, also serving to receive a rear wheel.

Preferably the inner tightening member is non-rotatably attached to the axle by at least one fastener. It is conceivable for the inner tightening member to be attached by a screw in the axial direction and/or non-rotatably connected with the axle by way of mating, non-round contours. The axle end may comprise a squared shaft end or an external hexagon with the inner tightening member shaped in a mating, non-round contour to non-rotatably connect the inner tightening member with the axle. Subsequently the inner tightening member can be fixedly connected with the axle in the axial direction by means of a screw in the axial direction. Adding an adhesive or the like onto the screw thread may secure this connection against unassisted disconnecting.

In other configurations it is conceivable for the inner tightening member to be integrally connected with the axle. Depending on the external diameter of the inner tightening member and depending on the inner hub diameter the inner tightening member may be guided through the hub or else the axle system is guided through the hub beginning at the second end. After guiding through the hub the end device is mounted to the second end.

In advantageous more specific embodiments the outer tightening member comprises a protruding lug. For mounting a front wheel fork of a bicycle this protruding lug may for example be disposed within the receiving opening or in the dropout receiving slot such that the protruding lug serves as an angle limiter, limiting or prohibiting a rotary movement of the outer tightening member relative to the bicycle fork or the two-wheeler component. It is also conceivable to provide a different or similar angle limiting device engaging in a hole at the dropout or being held at the dropout by a stopper. This allows to achieve reliable clamping solely by rotating the inner tightening member, without having to hold the outer tightening member. The inner tightening member is particularly preferably rotated by rotating the end piece which is non-rotatably connected with the axle which in turn is non-rotatably coupled with the inner tightening member.

This configuration allows a particularly advantageous, comfortable operation since rotating the operating lever on the end piece side enables an immediate clamping of the system. One hand operation is thus sufficient.

It is likewise conceivable for the operating lever to be provided, not at the end device but at the tightening device. Then the operating lever is preferably coupled with the outer tightening member for transmitting a rotary movement of the operating lever immediately to the outer tightening member. The outer tightening member transmits the rotary movement via the internal thread in the hollow cylindrical portion of the outer tightening member to thus axially displace the outer tightening member.

The operating lever may comprise a ratchet mechanism or a spring mechanism with a tensioning spring to allow rotation of the operating lever without affecting the clamping force.

In particular is an external diameter of the inner tightening member or an inner diameter of the outer tightening member at least 20% larger and in particular at least 40% and preferably at least 50% larger than the external axle diameter at the second end portion. A diameter of the outer tightening member or the internal thread of the outer tightening member 20% larger already allows a higher thread pitch per rotation such that the operating lever requires fewer rotations to increase or decrease the clamping length for example by e.g. 4 mm, 5 mm, or 6 mm.

In particular does the external thread of the tightening member show a ratio of external diameter to thread pitch per rotation of less than 14:1 and in particular less than 9:1 and preferably less than 7:1. By way of increasing the external diameter over the prior art a higher pitch per rotation is achieved with the ratio unchanged so as to allow a particularly comfortable operation.

In all of the configurations it is preferred for the external diameter of the inner tightening member to be larger than 7 mm, in particular larger than 9 mm and preferably larger than 12 mm and particularly preferably larger than 14 mm. External diameters of for example 16 mm or 18 mm or more are likewise conceivable.

Particularly preferably the thread pitch of the inner tightening member per full rotation is at least 1.0 mm or 1.2 mm and in particular at least 1.5 mm. The thread pitch may be 2 mm or still higher.

Advantageously the ratio of the external diameter of the inner tightening member to the axle diameter is at least 1.2. The ratio may exceed 1.5. The ratio of the outer diameter of the inner tightening member to the axle diameter at the second axle end is in particular at least 1.2 and in particular at least 1.4. In particular with—but not limited to—comparatively small axle diameters of e.g. 4 mm, 5 mm, or else 6 mm, the ratio of outer diameter of the inner tightening member to the axle diameter may be 1.5 or 2 or even more.

In a more specific embodiment the tightening device comprises a tightening sleeve. The tightening sleeve is provided for applying the clamping force to the outer tightening member and is connected with a lever. The lever is positioned to be movable relative to the outer tightening member in the axial direction of the axle and counter to the bias of at least one coil spring it is movable outwardly in the axial direction of the axle from an engaged position to a rotary position in which an angular position of the lever can be set independently of the state of tightening. The or at least one coil spring surrounds the outer tightening member in the radial direction at least in part.

Preferably one coil spring diameter is larger than is the outer diameter of the inner tightening member.

Another axle system according to the invention is in particular provided for a two-wheeled vehicle and comprises at least one axle and a clamping mechanism comprising at least one tightening device at a first axle end portion and at least one end device at a second axle end portion. The clamping mechanism is equipped to clampingly attach to a two-wheeler component a wheel received between the tightening device and the end device, the tightening device comprising an externally threaded, inner tightening member interacting with an internally threaded, outer tightening member, and a tightening sleeve. The outer tightening member and the inner tightening member are axially displaceable relative to one another by way of rotating the tightening sleeve. The tightening sleeve is provided for applying the tightening force to the external tightening member and is connected with a lever, the lever being positioned to be movable relative to the outer tightening member in the axial direction of the axle and counter to the bias of a coil spring it is movable outwardly in the axial direction of the axle from an engaged position to a rotary position in which an angular position of the lever can be set independently of the state of tightening. The coil spring surrounds the outer tightening member in the radial direction at least in part.

Preferably one coil spring diameter is larger than is the outer diameter of the inner tightening member.

In preferred embodiments the coil spring surrounds the engaging portion of the internal thread of the outer tightening member at least in part.

A coil spring diameter may be larger than an axle diameter.

An external diameter of the inner tightening member may be larger than an external axle diameter at the second end portion.

In further embodiments the axle system may comprise all or individual features of all of the embodiments described above.

The two-wheeler component according to the invention comprises first and second dropouts and an axle system to receive at least one wheel of a two-wheeler. The axle system comprises at least one axle and a clamping mechanism. The clamping mechanism includes at least one tightening device at a first axle end portion and at least one end device at a second axle end portion. The clamping mechanism is equipped to clampingly attach the axle received at a receiving opening of the first dropout and a receiving opening of the second dropout, between the tightening device and end device. The tightening device includes an externally threaded, inner tightening member interacting with an internally threaded, outer tightening member. The inner tightening member and the outer tightening member are axially displaceable for clamping by way of rotation. An outer diameter of the inner tightening member is larger than at least one diameter of at least one receiving opening and in particular of the first receiving opening and/or the second receiving opening.

The two-wheeler component according to the invention also has many advantages since it allows for particularly easy and comfortable mounting and demounting of wheels. The larger outer diameter of the inner tightening member allows a higher thread pitch thus allowing larger axial displacement of the outer tightening member. In this way a small number of rotary movements of the tightening lever allows to reliably and securely clamp the wheel.

In particular is the two-wheeler component according to the invention equipped with an axle system as it is described above.

Further advantages and features of the invention are shown in the exemplary embodiments which will be described below with reference to the enclosed figures.

The figures show in:

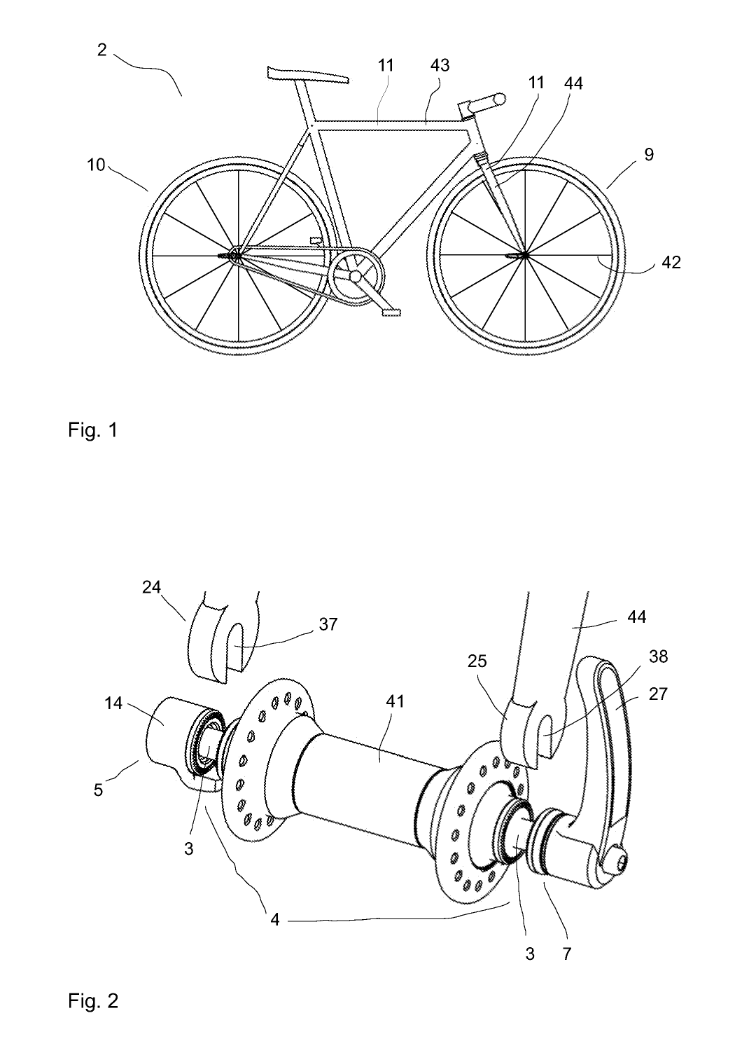

FIG. 1 a side view of an inventive bicycle;

FIG. 2 the axle system according to the invention with a hub at a bicycle fork;

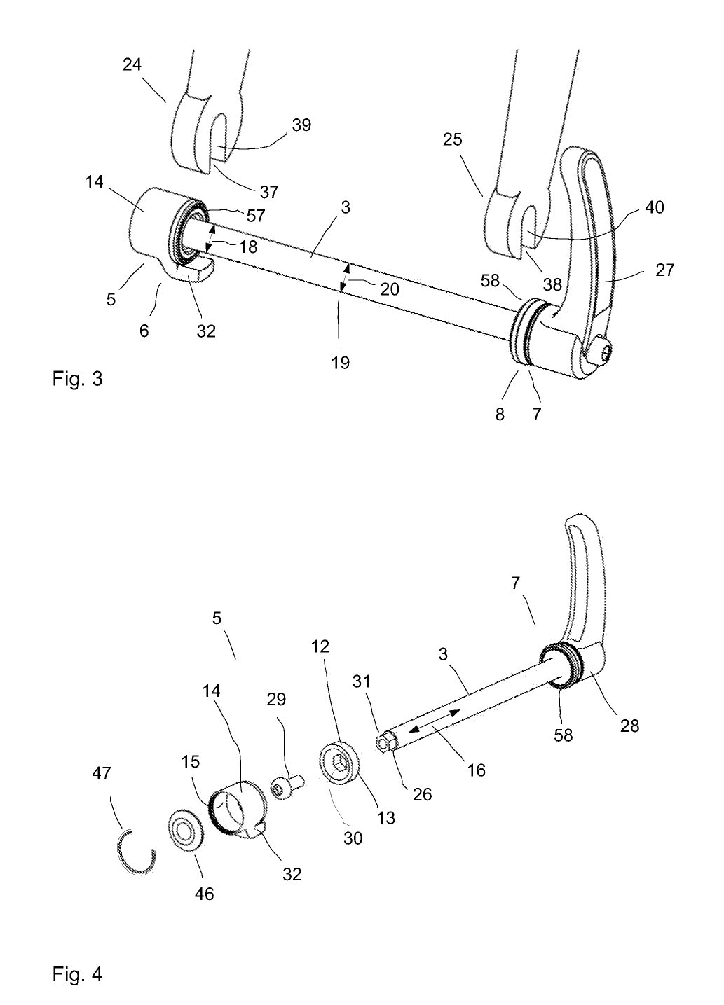

FIG. 3 the axle system according to the invention at a bicycle fork;

FIG. 4 the axle system according to FIG. 3 in a perspective, exploded view;

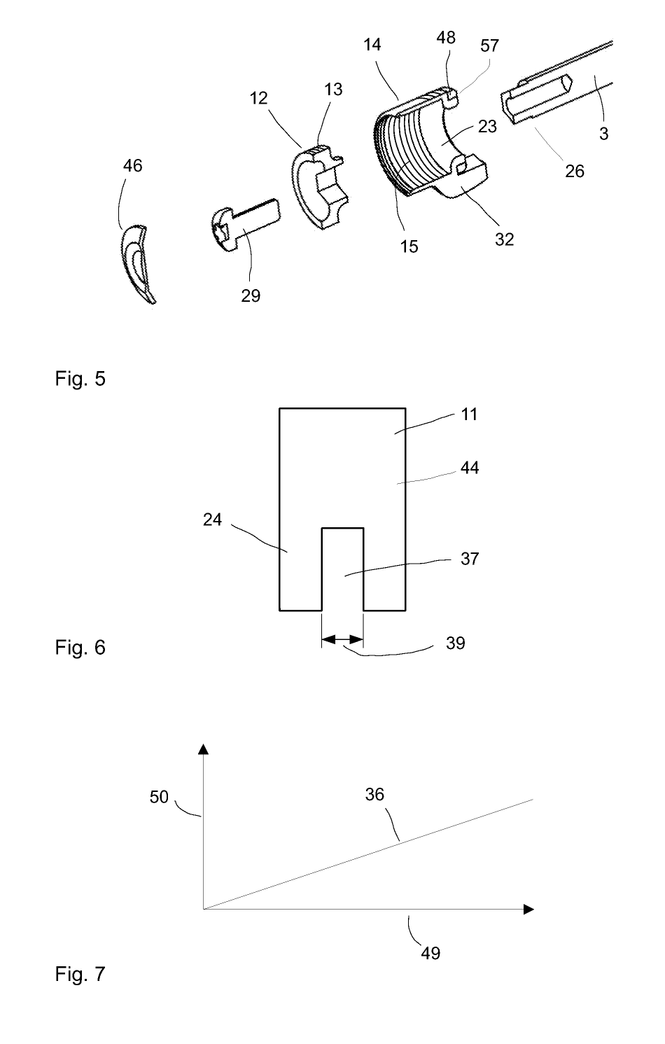

FIG. 5 a section view of part of the exploded view according to FIG. 4;

FIG. 6 a schematic side view of a dropout of a two-wheeler component;

FIG. 7 the thread pitch rise over the angle;

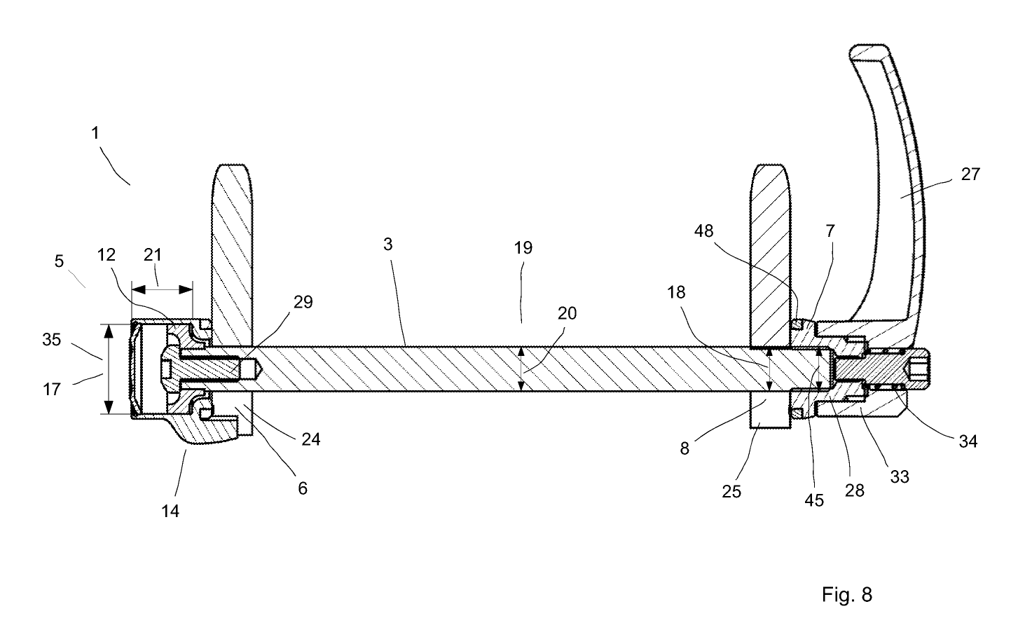

FIG. 8 a cross-section of an axle system installed in a bicycle component;

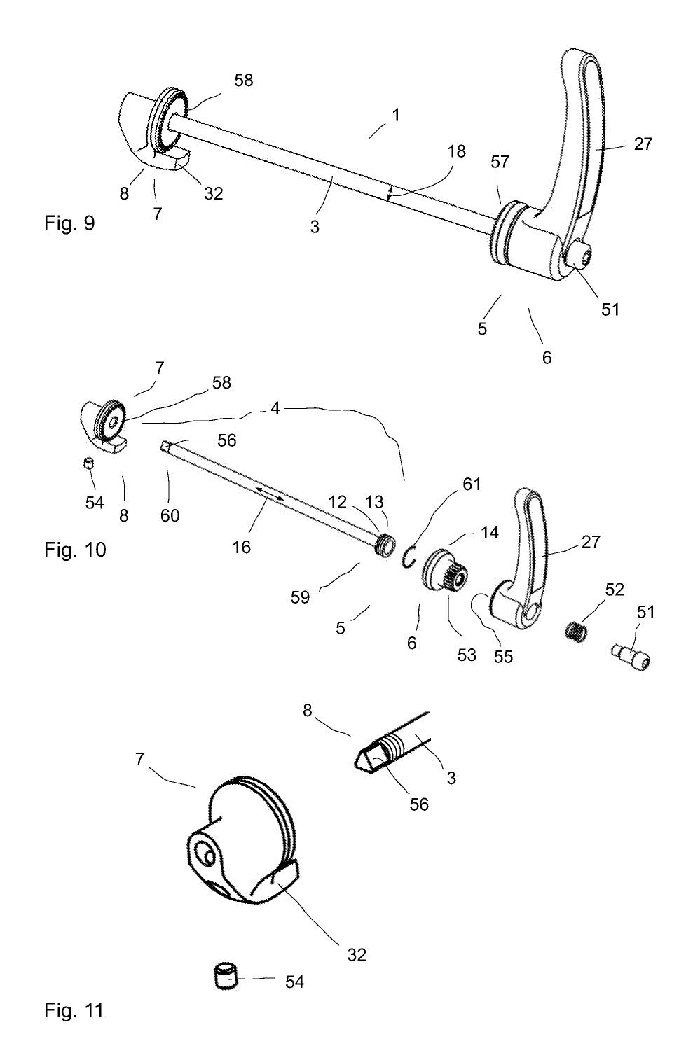

FIG. 9 another embodiment of an axle system 1 according to the invention in a perspective view;

FIG. 10 the axle system according to FIG. 10 in an exploded, perspective view;

FIG. 11 the end piece and the axle of the axle system according to FIG. 10 in an enlarged, perspective view;

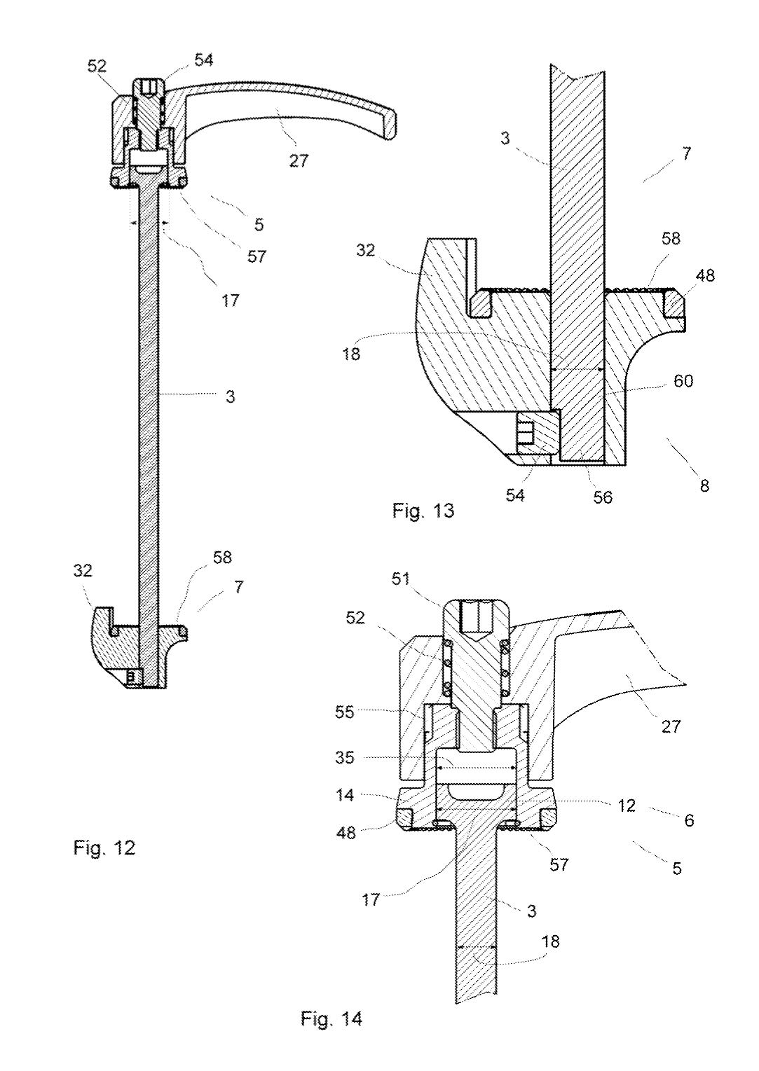

FIG. 12 a cross-section of the axle system according to FIG. 10;

FIG. 13 an enlarged cross-section of the end piece of the axle system according to FIG. 10;

FIG. 14 an enlarged cross-section of the tightening device of the axle system according to FIG. 10;

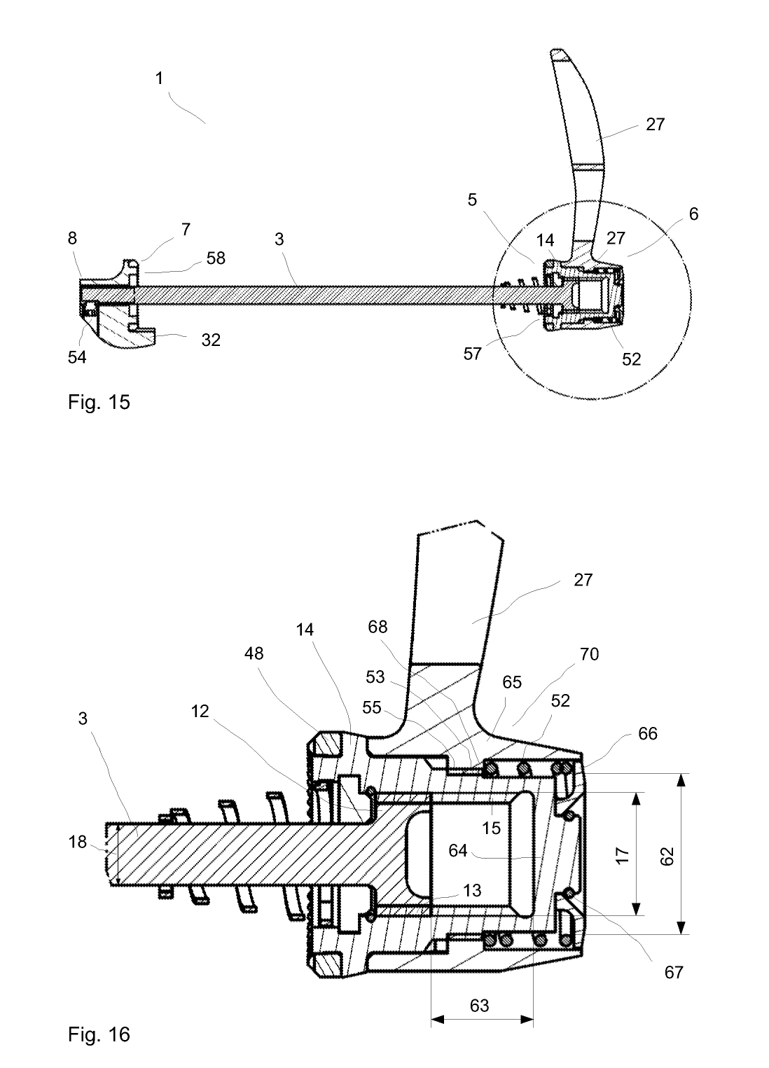

FIG. 15 a cross-section of another axle system; and

FIG. 16 an enlarged cross-section of the tightening device of the axle system according to FIG. 15.

With reference to the FIGS. 1 to 8 a first exemplary embodiment of an axle system according to the invention and of a two-wheeler component according to the invention will be discussed. FIG. 1 shows a side view of a bicycle 2 comprising a frame 43 as a bicycle component 11 and a bicycle fork 44 as a bicycle component 11.

The bicycle 2 is equipped with a wheel 9 and a wheel 10 and comprises a chain drive. Although FIG. 1 illustrates a roadster as the bicycle 2, a racing bicycle or a mountain-bike or another bicycle may also be equipped with the axle system 1 according to the invention. Use with electric bicycles or electrically assisted bicycles is conceivable as well.

FIG. 2 shows an enlarged illustration of an axle system 1 at which a hub 41 is received, illustrated shortly prior to inserting in, or shortly after removing from, the fork 44. The spokes 42 are not shown in the illustration of FIG. 2 for the sake of clarity.

The axle system 1 comprises an axle 3 extending from a first end portion 6 to a second end portion 8. The first end portion 6 is presently provided with the tightening device 5 of which substantially only the outer tightening member 14 is shown. The second end portion 8 is provided with the end device 7. This is where the operating lever 27 configured as a quick release lever is disposed.

Beneath the cover of the operating lever the end device 7 is provided with a mechanism which, after the operating lever is pulled away from the hub 41 in the axial direction, allows to freely displace the operating lever relative to the end device 7. Thus the user may first rotate the operating lever to clampingly receive the wheel and thereafter pull it out axially, and freely rotate it to a desired position without affecting the clamped state.

The axle system 1 is received at the dropouts 24 and 25 with the receiving openings 37 and 38 provided thereat. On the whole the clamping mechanism 4 comprises, for clamping the hub 41 or a wheel 9 or 10, the tightening mechanism 5 on the one side, and the end device 7 on the other side. In other configurations it is likewise conceivable for the operating lever to be provided on the tightening device side.

FIG. 3 shows an illustration corresponding to FIG. 2 with the hub 41 omitted for the sake of clarity.

The axle 3 has an outer diameter 18 at the first end portion 6. There the axle 3 has over its entire length and thus including the center portion 19, a diameter 20 corresponding to the diameter 18 in the first end portion. It is likewise possible for the axle 3 to have different diameters over its length.

To attach a wheel with the axle system 1 for example to the fork 44, the axle system is inserted from beneath into the slot-type receiving openings 37 and 38 of the dropouts 24 and 25. The diameters or clear dimensions 39 and 40 of the receiving openings 37 and 38 are configured such that they are somewhat larger than is the outer diameter 18 of the axle 3 so as to ensure inserting and accurate fit of the axle 3.

The tightening device 5 is provided with a lug 32 as a rotation limiter which is also inserted into the receiving opening 37 of the dropout 24. Due to the lug 32 the outer tightening member 14 is prohibited from rotating any further but it can only be axially displaced due to the rotary movement of the inner tightening member 12 disposed therein.

For better clarity of each of the components FIG. 4 shows a perspective, exploded view of the tightening device 5 of the axle system 1. The axle 3 comprises at its first end 26 a polygon, presently hexagon, non-round contour 31 which with its external dimensions mates with the internal dimensions of the non-round contour 30 of the inner tightening member 12. Placing the inner tightening member 12 onto the end 26 of the axle 3 in the axial direction 16 thus ensures that the inner tightening member 12 is non-rotatable relative to the axle 3. The screw 29 which serves as a locking screw is then threaded into the end 26 of the axle 3, securing the inner tightening member 12 in the axial direction. To prevent rapping off and to ensure permanent attachment, an adhesive may be applied to the thread prior to threading in the screw 29. When the adhesive is cured, a durable and secure connection is thus possible.

Adjacent thereto the outer tightening member 14 is shown, comprising the lug 32 described above. The inner periphery of the outer tightening member 14 is provided with an internal thread 15 which when assembled interacts with the external thread 13 on the outer periphery of the inner tightening member 12.

A cover plate 46 is provided towards the axial end serving as an axial end plate and secured via a circlip 47.

FIG. 5 shows a half-sectional view of the components of the tightening device 5 of FIG. 4 in the mounting sequence with the hatching of each component omitted. At the end 26 of the axle 3 one can clearly recognize the receiving opening with the internal thread for receiving the screw 29 to attach the inner tightening member 12 to the axle 3 in the axial direction. Prior to attaching the inner tightening member 12 to the axle 3, the outer tightening member 14 is pushed onto the end 26 of the axle 3.

When the outer tightening member 14 has been pushed on and the inner tightening member 12 has been mounted and secured via the screw 29, the inner stopper 23 of the outer tightening member 14 and the stopper 22 of the inner tightening member 12 prohibit axial displacement of the outer tightening member beyond the inner tightening member. This ensures anti-loss protection of the outer tightening member 14. Or else it is conceivable to provide an outer tightening member 14 without a stopper 23. It is possible to realize the outer tightening member 14 without any anti-loss protection or else by other ways and types of anti-loss protection.

FIG. 6 shows a simplistic view of a dropout 24 of a bicycle fork 44. The receiving opening 37 comprises a free cross-section or diameter 39 which serves to receive the outer diameter 18 of the axle 3.

FIG. 7 is a pitch diagram of the rise 50 of the thread pitch 36 over the peripheral length. Since the circumference of a thread increases in proportion with the thread diameter, FIG. 7 clearly shows that a doubled outer thread diameter achieves a doubled thread pitch per rotation. This means that, for overcoming a gap of 5 mm, a conventional axle system having an axle with an outer diameter of for example 9 mm and 1 mm thread pitch per axle rotation requires a total of five turns, while given an outer diameter of 13.5 mm and a pitch of 1.5 mm per axle rotation, only three and one third turns are required for the outer tightening member to be axially displaced by the desired distance. When the thread pitch is additionally increased, the number of turns required may be reduced still further to e.g. one half or still less.

FIG. 8 shows a cross-section of the axle system 1 mounted in a fork 44.

The first portion 6 is provided at its first end 26 with the tightening device 5 which presently consists of the inner tightening member 12, the outer tightening member 14, the screw 29 and the cover plate 46 and the circlip 47.

The inner tightening member 12 is attached to the first axial end 26 of the axle 3 by means of the screw 29. The inner tightening member 12 comprises an external thread 13. The inner tightening member 12 is radially surrounded by the outer tightening member 14 which comprises a hollow cylindrical section 21 with an internal thread 15. The internal thread 15 of the outer tightening member 14 engages with the external thread 13 of the inner tightening member 12.

The inner diameter 35 of the hollow cylindrical section 21 approximately corresponds to the external diameter 17 of the inner tightening member 12 or the external diameter of the external thread of the inner tightening member 12. Within the scope of accuracy of the drawing at the present scale no difference can be seen.

The tightening device 5 is received in the first dropout 24 while the end piece 7 is received at the dropout 25.

Both the end piece 7 and the outer tightening member 14 may be provided with knurled disks 48 which serve to contact the corresponding clamping surfaces of the two-wheeler component 11 and which may be configured rotatable relative to the outer tightening member 14 or the end device 7 respectively. As can clearly be seen from the illustration according to FIG. 8, the outer diameter 18 of the axle 3 is virtually constant over the entire axle length. In particular does the external diameter 18 in the region of the receiving openings 37 and 38 and in the end portions 6 and 8 also correspond to the external diameter 20 in a central portion 19 of the axle 3.

The external diameter 18 is presently considerably smaller than the external diameter 17 of the inner tightening member 12 so as to allow a clearly higher thread pitch of the external thread 13 and the internal thread 15 at the inner tightening member 12 and the outer tightening member 14. In this way one turn of the operating lever 27 achieves a considerably larger axial displacement of the outer tightening member 14 so as to allow a very comfortable and simpler adjustment of the clamping force.

The tensioning lever 27 may be provided with a ratchet mechanism 33 having a tensioning spring 34 that is in particular configured as a coil spring 52 to allow disengagement and free return rotation of the operating lever 27.

The FIGS. 9 to 14 illustrate another exemplary embodiment of an axle system 1 according to the invention wherein the axle 3 of the axle system 1 presently has a smaller external diameter 18.

Although the external diameter 18 of the axle illustrated is substantially constant, it may be configured stepped relative to the length of the axle. In the present exemplary embodiment the axle 3 is designed to be pushed through a conventional, commercially available hub. This is why the second end 60 of the axle 3 is configured with an external diameter 18 which passes through the typical axle openings of conventional hubs. Conventional hubs tend to show a 5 mm axle diameter with a mating external diameter, being approximately 5 mm. For other configurations a different external diameter 18 may be chosen for the axle.

FIG. 9 shows an overall view of the axle system 1. As is illustrated in FIG. 10 in a perspective, exploded drawing, this exemplary embodiment is provided with the operating lever 27 at the first end portion 6 at the tightening device 5. The second end portion 8 is provided with the end device 7 into which the second end 60 of the axle is inserted and screwed in. To lock the axle 3 against rotation at the end device 7, a headless screw is provided as a rotation lock 54 which is screwed against a non-round contour 56 at the second end 60 of the axle 3 to prohibit the axle 3 from rotating relative to the end device 7 during clamping or in operation.

The first end 59 of the axle 3 is provided with the inner tightening member 12 with the external thread 13 with the inner tightening member 12 presently being an integral component of the axle 3 with which it may be formed integrally.

The operating lever 27 is held at the outer tightening member 14 by a screw 51 and a spring 34 configured as a coil spring 52, so as to be axially displaceable though biased toward the outer tightening member 14, wherein the coil spring 52 urges the operating lever 27, which is equipped with an inner toothing, into engagement with the outer toothing 53 of the outer tightening member 14. Such engagement of the inner toothing 55 at the operating lever 27 in the outer toothing 53 at the outer tightening member 14 thus ensures that as the operating lever 27 is rotated, the outer tightening member 14 rotates along such that the outer tightening member 14 and the inner tightening member 12 are axially displaced relative to one another. To allow rotation of the operating lever 27 to any direction desired without affecting the clamping force, the operating lever 27 may be pulled out axially against the force of the coil spring 52 until the inner toothing 55 ceases to engage with the inner toothing 53 following which the operating lever 27 can be rotated freely.

In the case of engagement, rotating the operating lever 27 turns the outer tightening member 14 whose internal thread 15 is in engagement with the external thread 13 of the inner tightening member 12. To ensure that the outer tightening member 14 cannot be screwed off, a retaining ring 61 is provided.

The fact that the inner tightening member 12 has an external diameter 17 that is considerably larger than the external diameter 18 of the axle 3, allows to provide the thread 13 with a clearly higher pitch than if the thread 13 were provided at an external diameter 18. The larger external diameter 17 of the external thread 13 causes the thread 13 to be safely self-locking notwithstanding the higher pitch. Due to the higher pitch a clearly larger axial displacement is achieved with a specific rotary movement such that overcoming an axial distance of for example 5 mm requires a considerably smaller number of turns of the operating lever 27.

If for example, instead of a typical thread of 0.8 mm pitch at an axle of 5 mm diameter, an external diameter of 10 mm is chosen for the inner tightening member 12, then a standard thread of 1.5 mm pitch may be employed. Higher pitches are likewise conceivable. In this way the number of turns required for safely tightening the axle system 1 is approximately halved.

Moreover, all the safety requirements are met and even if the operating lever 27 is rotated once, the axle system 1 is held at a two-wheeler component secure against loss.

The lug 32 as the angle limiter for the end device 7 is inserted in the slot of the receiving opening 37 of the dropout 24 in mounting, thus preventing the end device 7 from rotating along. This allows one-hand operation since the user first inserts the wheel to be mounted to a bicycle frame, a rear wheel link fork or a bicycle fork, then holds the bicycle for example with one hand while with the other hand actuating the operating lever 27 for tightening the wheel. Using two hands is not required for tightening.

FIG. 11 shows an enlarged, perspective view of the end 60 of the axle 3 at which the non-round profile 56 is provided. The non-round profile 56 may in particular be configured as a polygon and be for example approximately triangular in cross-section. Other cross-sections allowing a lock against rotation of the axle 3 relative to the end device 7 are likewise conceivable. For an axial lock against rotation, after screwing the axle 3 into the end device 7 the headless screw 54 is inserted in the hole visible perpendicular to the axle direction where it is screwed against the non-round contour 56 of the axle 3 to ensure a lock against rotation.

FIG. 12 shows an overall cross-section through the axle system 1 which clearly shows the diameter ratios between the external diameter 17 of the inner tightening member 12 and the external diameter 18 of the axle 3. The external diameter 17 is presently twice the external diameter 18.

FIGS. 13 and 14 show enlarged cross-sections of the second end portion 7 and the first end portion 6.

FIG. 13 illustrates an enlarged cross-section of the second end portion 8 with the end device 7. The clamping surface 58 with the knurled disk 48 is illustrated at the end device 8. The non-round profile 56 is secured by means of the lock against rotation 54 configured as a headless screw.

In the second end portion 8 and in particular also at the second end 60 the diameter 18 is considerably smaller than the external diameter 17 of the inner tightening member 12.

FIG. 14 illustrates the first end portion 6 with the tightening device 5 with the operating lever 27 in the present exemplary embodiment provided at the first end portion 6, acting on the outer tightening member 14. To this end the outer tightening member 14 is provided with an outer toothing 53 interacting with an inner toothing 55 at the operating lever 27. The outer tightening member 14 is provided with a knurled disk 48 which provides the clamping surface 57 of the tightening device 5. This exemplary embodiment allows easy retrofitting of existing hubs involving reduced effort in changing wheels and achieving a high level of security.

FIGS. 15 and 16 show another exemplary embodiment. FIG. 15 represents an overall cross-section through the axle system 1 which in turn shows the diameter ratios between the external diameter 17 of the inner tightening member 12 and the external diameter 18 of the axle 3. The external diameter 17 is presently again about twice the size of the external diameter 18.

The second end portion 8 with the end device 7 is preferably structured as in the exemplary embodiment according to FIG. 12. The end device 8 in turn is provided with the clamping surface 58 with the knurled disk 48. The non-round profile 56 is secured by means of the lock against rotation 54 configured as a headless screw.

In the second end portion 8 and in particular also at the second end 60 the diameter 18 is considerably smaller than the external diameter 17 of the inner tightening member 12. In the center portion of the axle 3 (e.g. where the reference numeral 3 of the axle is drawn in FIG. 15) the external diameter of the axle 3 is again considerably smaller than the external diameter 17 at the inner tightening member 12.

FIG. 16 shows an enlarged cross-section of the first end portion 6.

In FIG. 16 the first end portion 6 with the tightening device 5 is illustrated. The operating lever 27 is provided at the first end portion 6. The tightening device comprises a tightening sleeve 65 to which the operating lever 27 is fastened. The operating lever 27 may be configured as a separate part and fastened to the tightening sleeve 65, or else the operating lever 27 is manufactured integrally with the tightening sleeve. The lever or operating lever 27 acts, through the tightening sleeve 65 with which it is fixedly connected, on the outer tightening member 14.

To this end the outer tightening member 14 is in turn provided with an outer toothing 53 interacting with an inner toothing 55 at the tightening sleeve 65. The outer tightening member 14 is provided with a knurled disk 48 which provides the clamping surface 57 of the tightening device 5. This exemplary embodiment allows easy retrofitting of existing hubs involving reduced effort in changing wheels and achieving a high level of security.

Rotating the operating lever 27 causes the tightening sleeve 65 to rotate along such that the outer tightening member 14 rotates along as well, if the tightening sleeve is in engagement with the outer tightening member 14. The relative rotation of the outer tightening member 14 relative to the inner tightening member 12 causes axial displacement of the outer tightening member 14. Depending on the rotational direction, the axle system 1 is e.g. clamped to a bicycle fork or else a clamping is released.

In the engaged state 70 illustrated in FIG. 16 the tightening sleeve 65 and the outer tightening member 14 are engaged with one another. The tightening sleeve 65 is biased in the axial direction toward the outer tightening member 14 by means of the biasing force of the coil spring 67. The coil spring 52 is presently supported at a disk 66 which is connected with the outer tightening member 14. The other end of the coil spring 52 abuts against a shoulder 68. This is where in the engaged state 70 the outer toothing 53 of the outer tightening member 14 is in engagement with the inner toothing 55 of the tightening sleeve 65. In this way a rotary movement of the tensioning lever 27 is transmitted via the tightening sleeve 65 to the outer tightening member 14 and the axle system 1 is e.g. clamped.

Now when the tightening lever 27 is moved axially outwardly counter to the biasing force of the biasing spring 66 far enough for the outer toothing 53 of the outer tightening member 14 to disengage from the inner toothing 55 of the tightening sleeve 65, then a rotary position is present. In the rotary position the tightening lever 27 and thus the tightening sleeve 65 can be rotated relative to the outer tightening member 14. This is useful e.g. for moving the tensioning lever 27 to a desired angular position following a tensioning operation, or else for continuing the tensioning movement after rotating the tensioning lever back in case that the tensioning lever 27 cannot be turned completely round due to external circumstances.

When the tensioning lever 27 is released while in the axially deflected rotary position then the tensioning lever 27 with the tightening sleeve 65 is again moved axially in the direction toward the outer tightening member 14 due to the biasing force of the coil spring 52. The inner toothing 55 of the tightening sleeve 65 again comes into engagement with the outer toothing 53 of the outer tensioning member 14 such that the tensioning lever 27 is fixed in its angular position.

The configuration of the exemplary embodiment according to FIG. 15 enables an enlarged stroke length of the tensioning mechanism. A diameter 62 of the coil spring 52 and in particular the inner diameter of the coil spring 52 is larger than an outer diameter 17 of the outer tensioning member 14. This allows the coil spring 52 to radially surround the outer tensioning member 14 at least over a portion. This allows to enlarge the possible axial stroke length 63. Or else it is possible to shorten the axial construction length.

Given such a configuration the inner tensioning member 12 may have the same outer diameter 18 as does the axle 3 or else a slightly larger outer diameter. The inner diameter of the outer tightening member 14 is adapted accordingly.

In the present exemplary embodiment according to the FIGS. 15 and 16 the tightening sleeve 65 comprises a lid 64 for an axially outwardly cover. The coil spring 52 is held through a disk 66 fastened to the lid 64 by means of a circlip 67 or the like.

Or else it is conceivable to fasten the coil spring to the outer tightening member 14 via a screw head of a screw 51 (see FIG. 14). Or it is conceivable for the screw head of a screw 51 to hold a disk 66 which in turn axially biases the coil spring 52.

On the whole the invention provides an axle system and a two-wheeler component equipped with such an axle system with which high operating comfort and high security can be achieved.

### LIST OF REFERENCE NUMERALS

| | |
|---|---|
| 1 | Axle system |
| 2 | bicycle |
| 3 | axle |
| 4 | clamping mechanism |
| 5 | tightening device |
| 6 | first end portion |
| 7 | end device |
| 8 | second end portion |
| 9 | wheel |
| 10 | wheel |
| 11 | bicycle component |
| 12 | inner tightening member |
| 13 | external thread |
| 14 | outer tightening member |
| 15 | internal thread |
| 16 | axial direction |
| 17 | outer diameter |
| 18 | outer diameter |
| 19 | central region |
| 20 | outer diameter |
| 21 | portion |
| 22 | stopper |
| 23 | stopper |
| 24 | dropout |
| 25 | dropout |
| 26 | first end |
| 27 | operating lever |
| 28 | second end |
| 29 | locking screw |
| 30 | non-round contour |
| 31 | non-round contour |
| 32 | lug |
| 33 | ratchet mechanism |
| 34 | tensioning spring |
| 35 | inner diameter |
| 36 | thread pitch |
| 37 | receiving opening |
| 38 | receiving opening |
| 39 | diameter |
| 40 | diameter |
| 41 | hub |
| 42 | spoke |
| 43 | frame |
| 44 | fork |
| 45 | diameter |
| 46 | cover plate |
| 47 | circlip |
| 48 | knurled disk |
| 49 | angle |
| 50 | rise |
| 51 | screw |
| 52 | spring |
| 53 | outer toothing |
| 54 | lock against rotation |
| 55 | inner toothing |
| 56 | non-round profile |
| 57 | clamping surface |
| 58 | clamping surface |
| 59 | first end |
| 60 | second end |
| 61 | retaining ring |
| 62 | inner diameter |
| 63 | length |
| 64 | lid |
| 65 | tightening sleeve |
| 66 | disk |
| 67 | circlip |
| 68 | shoulder |
| 70 | engaged state |

1. An axle system for a two-wheeled vehicle having at least one axle and a clamping mechanism, comprising at least one tightening device at a first end portion of the axle and at least one end device at a second end portion of the axle, the clamping mechanism being equipped to clampingly attach to a two-wheeler component a wheel received between the tightening device and the end device,
characterized in
that the tightening device comprises an inner tightening member having an external thread and an outer tightening member interacting therewith and having an internal thread, which for tightening are axially displaceable against one another by rotation, an external diameter of the inner tightening member being larger than an external diameter of the axle at the second end portion.

2. The axle system according to claim 1, the outer tightening member and the inner tightening member each comprising a stopper for limiting axial displacement of the inner and the outer tightening members in the direction of the first end portion.

3. The axle system according to claim 1, the outer tightening member comprising a clamping surface for placement against a two-wheeler component (11).

4. The axle system (1) according to claim 1, the inner tightening member being non-rotatably attached to the axle by means of at least one fastener.

5. The axle system according to claim 1, wherein the inner tightening member is fastened by a screw in the axial direction and/or non-rotatably connected with the axle by way of mating, non-round contours.

6. The axle system according to claim 1, the outer tightening member comprising a protruding lug which is in particular suitable to be received at a receiving opening of a dropout.

7. The axle system according to claim 1, wherein the clamping mechanism is provided with an operating lever.

8. The axle system according to claim 1, wherein the operating lever is provided at the end device.

9. The axle system according to claim 1, wherein the operating lever is provided at the tightening device.

10. The axle system according to claim 1, wherein the operating lever comprises a ratchet mechanism and a tensioning spring.

11. The axle system according to claim 1, wherein an external diameter of the inner tightening member and/or an inner diameter of the outer tightening member is at least 20% larger than the external diameter of the axle at the second end portion.

12. The axle system according to claim 1, wherein the external thread of the inner tightening member shows a ratio of external diameter to thread pitch per rotation of less than fourteen.

13. The axle system according to claim 1, wherein the external diameter of the inner tightening member is larger than 9 mm.

14. The axle system according to claim 1, wherein the thread pitch of the external thread of the inner tightening member per full rotation is higher than 1.2 mm.

15. The axle system according to claim 1, wherein the ratio of the external diameter of the inner tightening member to the axle diameter is larger than 1.2.

16. The axle system according to any of the preceding claims wherein the tightening device comprises a tightening sleeve and wherein the tightening sleeve is provided for applying the tightening force to the outer tightening member and is connected with a lever,
the lever being positioned to be movable relative to the outer tightening member in the axial direction of the axle and counter to the bias of a coil spring it is movable outwardly in the axial direction of the axle from an engaged position to a rotary position in which an angular position of the lever is adjustable independently of the state of tightening
wherein the coil spring radially surrounds the outer tightening member at least in part.

17. The axle system according to any of the preceding claims wherein a diameter of the coil spring is larger than the external diameter of the inner tightening member.

18. An axle system for a two-wheeled vehicle having at least one axle and a clamping mechanism, comprising at least one tightening device at a first end portion of the axle and at least one end device at a second end portion of the axle, the clamping mechanism being equipped to clampingly attach to a two-wheeler component a wheel received between the tightening device and the end device,
the tightening device comprising an inner tightening member having an external thread and an outer tightening member interacting therewith and having an internal thread and a tightening sleeve, the outer tightening member and the inner tightening member being axially displaceable against one another by rotation,
wherein the tightening sleeve is provided for applying the tightening force to the outer tightening member and is connected with a lever,
the lever being positioned to be movable relative to the outer tightening member in the axial direction of the axle and counter to the bias of a coil spring it is movable outwardly in the axial direction of the axle from an engaged position to a rotary position in which an angular position of the lever is adjustable independently of the state of tightening
wherein the coil spring radially surrounds the outer tightening member at least in part.

19. The axle system according to the preceding claim wherein a diameter of the coil spring is larger than the external diameter of the inner tightening member.

20. The axle system according to claim 18, wherein the coil spring surrounds the engaging portion of the internal thread of the outer tightening member at least in part.

21. The axle system according to claim 18 wherein a diameter of the coil spring is larger than a diameter of the axle.

22. The axle system according to claim 18 wherein an outer diameter of the inner tightening member is larger than an outer diameter of the axle at the second end portion.

23. A two-wheeler component comprising a first dropout and a second dropout and an axle system for receiving at least one wheel of a two-wheeled vehicle, the axle system being provided with at least one axle and a clamping mechanism, the clamping mechanism comprising at least one tightening device at a first end portion of the axle and at least one end device at a second end portion of the axle, the clamping mechanism being equipped to clampingly attach the axle received at a receiving opening of the first dropout and at a receiving opening of the second dropout, between the tightening device and the end device,
characterized in
that the tightening device comprises an inner tightening member having an external thread and an outer tightening member interacting therewith having an internal thread, which for tightening are axially displaceable against one another by rotation, an external diameter of the inner tightening member being larger than at least one diameter of the first and/or the second receiving opening.

24. The two-wheeler component according to the preceding claim wherein at least one axle system according to any of the preceding claims is provided.
